(19) United States
(12) Patent Application Publication
(10) Pub. No.: US 2015/0346541 A1
(43) Pub. Date: Dec. 3, 2015

(54) DISPLAY DEVICE

(71) Applicant: Funai Electric Co., Ltd., Osaka (JP)

(72) Inventors: Satoshi ANDO, Osaka-shi (JP); Tatsuji SUDO, Osaka-shi (JP)

(21) Appl. No.: 14/724,882

(22) Filed: May 29, 2015

(30) Foreign Application Priority Data
May 29, 2014 (JP) 2014-111516

(51) Int. Cl. G02F 1/1333; F21V 8/00

(52) U.S. Cl. CPC G02F 1/133308; G02B 6/005; G02B 6/0088; G02B 6/0065; G02F 2001/133317

(57) ABSTRACT

A television includes a liquid crystal cell, a light source unit, a light guide plate that includes a light entrance surface containing a side end surface through which light emitted from the light source unit enters, and guides light emitted from the light source unit and entering the light entrance surface such that the light travels toward the liquid crystal cell, and a mold frame disposed between the light guide plate and the liquid crystal cell, and supporting the liquid crystal cell. The television includes an elastic member disposed between the light guide plate and the mold frame, brought into contact with the light guide plate in an elastically deformed state of the elastic member, and exhibiting non-translucency to prevent transmission of light.

### BACKGROUND OF THE INVENTION

1. Field of the Invention

The present invention relates to a display device, and more particularly to a display device which includes a member disposed between a light guide plate and a display unit support member.

2. Description of the Related Art

A display device known in the art includes a member disposed between a light guide plate and a display unit support member (for example, see JP 2005-91971 A).

A liquid crystal display apparatus disclosed in JP 2005-91971 A includes a liquid crystal display panel, a mold (display unit support member) for supporting the liquid crystal display panel, a backlight device disposed on the mold on the side opposite to the liquid crystal display panel, and an optical compensation film. The backlight device includes a light guide plate, and a cold cathode fluorescent lamp disposed on a side end surface of the light guide plate. The optical compensation film is disposed on the liquid crystal display panel side surface of the light guide plate at a position between the liquid guide plate and the mold. A rubber cushion is provided between the optical compensation film (light guide plate) and the mold. The rubber cushion is disposed in a tight contact with the optical compensation film and the mold without compressive deformation.

According to the liquid crystal display apparatus disclosed in JP 2005-91971 A, which includes the rubber cushion disposed in a tight contact with the optical compensation film and the mold without compressive deformation, a clearance is produced between the mold and the optical compensation film (light guide plate) when the mold warps. In this case, light emitted from the cold cathode fluorescent lamp leaks through the clearance toward the liquid crystal display panel. As a result, a position around the cold cathode fluorescent lamp in the liquid crystal display panel becomes bright, while a position spaced away from the cold cathode fluorescent lamp in the liquid crystal display panel becomes dark. This situation causes a problem of uneven brightness (luminance unevenness) of a display image displayed on the liquid crystal display panel.

### SUMMARY OF THE INVENTION

Preferred embodiments of the present invention provide a display device capable of significantly reducing or preventing uneven brightness (luminance unevenness) of a display image displayed on a display unit.

A display device according to an aspect of various preferred embodiments of the present invention includes a display unit; a light source unit; a light guide plate that includes a light entrance surface including a side end surface through which light emitted from the light source unit enters, and guides light emitted from the light source unit and entering the light entrance surface such that the light travels toward the display unit; a display unit support member disposed between the light guide plate and the display unit, and supporting the display unit; and an elastic member disposed between the light guide plate and the display unit support member, brought into contact with the light guide plate in an elastically deformed state of the elastic member, and having non-translucency to prevent transmission of light.

According to the display device of the one aspect of various preferred embodiments of the present invention as noted above, the non-translucent elastic member capable of preventing transmission of light is provided between the light guide plate and the display unit support member, and brought into contact with the light guide plate in a state of elastic deformation of the elastic member. In this case, the elastic member sandwiched between the light guide plate and the display unit support member and contacting the light guide plate in the state of elastic deformation is deformable in accordance with a change of the clearance between the light guide plate and the display unit support member as a result of a warp or the like produced in the display unit support member. This structure prevents generation of a clearance between the light guide plate and the elastic member. Accordingly, this structure reduces light emitted from the light source unit, passing through a clearance between the light guide plate and the elastic member, and entering the display unit, and thus reduces a bright area around the light source unit in the display unit, and a dark area spaced away from the light source unit in the display unit. As a result, uneven brightness (luminance unevenness) of a display image displayed on the display unit decreases.

The display device according to the one aspect of various preferred embodiments of the present invention preferably further includes an optical sheet disposed on the elastic member on the side opposite to the light source unit. In this case, at least a portion of the elastic member outside a side end surface of the optical sheet on the light source unit side is brought into contact with the light guide plate. According to this structure, the elastic member in contact with the light guide plate outside the side end surface of the optical sheet on the light source unit side reduces light emitted from the light source unit, passing through a clearance between the light guide plate and the elastic member, and entering the side end surface of the optical sheet on the light source unit side. This structure reduces a bright area around the light source unit in the display unit produced as a result of an effect of light having entered the side end surface of the optical sheet on the light source unit side, and a dark area away from the light source unit in the display unit, and thus reduces uneven brightness of a display image displayed on the display unit.

According to the display device of the above aspect of various preferred embodiments of the present invention, the light source unit preferably includes a plurality of light emitting elements arranged in an extension direction of a side end surface of the light guide plate, and the elastic member is preferably disposed to extend in the extension direction of the side end surface of the light guide plate. According to this structure, the elastic member reduces uneven brightness of a display image displayed on the display unit in a wide range of the display image in the extension direction of the side end surface of the light guide plate. In addition, the elastic member prevents generation of a clearance between the light guide plate and the elastic member, thus reducing light emitted from the respective light emitting elements as point light sources, passing through a clearance between the light guide plate and the elastic member, and entering the display unit. This structure reduces dark areas confronting portions between the light emitting elements on the light source unit side of the display unit, and extremely bright areas confronting the light emitting elements on the light source unit side of the display unit (so-called a phenomenon of hot spots), thus effectively reducing or preventing uneven brightness of a display image displayed on the display unit. Accordingly, this structure eliminates the necessity of reducing the intervals between the light emitting elements by raising the number of the light emitting elements for preventing hot spots, thus avoiding a rise of the number of the light emitting elements. In addition, this structure allows reduction of a distance between the light emitting elements and an opening of the display unit support member, while decreasing the hot spots without the need for a rise of the number of the light emitting elements. Accordingly, size reduction of the display device by the corresponding distance is achievable.

According to the display device of the above aspect of various preferred embodiments of the present invention, the elastic member is preferably made of non-translucent foam material, for example. According to this configuration, foam material is easy to elastically deform and also flexible when containing air. In this case, the elastic member exhibiting non-translucency elastically deforms with ease in such a manner as to come into tight contact with the light guide plate. This structure effectively prevents generation of a clearance between the light guide plate and the elastic member.

The display device of the above aspect of various preferred embodiments of the present invention preferably further includes a light guide plate support member disposed on the light guide plate on the side opposite to the elastic member, and configured to be less elastically deformable than the elastic member. This structure effectively prevents elastic deformation of the light guide plate support member rather than elastic deformation of the elastic member when the elastic member is pressed against the light guide plate toward the light guide plate support member for elastic deformation of the elastic member. Accordingly, this structure brings the elastic member into contact with the light guide plate with sufficient elastic deformation of the elastic member.

In this case, the light guide plate support member is preferably configured to be substantially non-deformable in an elastic manner. This structure brings the elastic member into contact with the light guide plate with sufficient elastic deformation of the elastic member and substantially without elastic deformation of the light guide plate support member.

According to the display device of the above aspect of various preferred embodiments of the present invention, the display unit support member preferably includes a recess on which the elastic member is disposed. According to this structure, the recess facilitates positioning of the elastic member on the display unit support member, and prevents positional deviation of the elastic member with respect to the display unit support member.

According to the display device of the above aspect of various preferred embodiments of the present invention, the elastic member is preferably disposed in such a condition as to press the side end surface of the optical sheet on the light source unit side, and surroundings of this side end surface. According to this structure, the elastic member pressing the side end surface of the optical sheet on the light source unit side, and surroundings of this side end surface prevents positional deviation of the optical sheet, thus reducing damage to the light guide plate caused by positional deviation of the optical sheet as a result of vibrations or the like.

As described above, reduction or prevention of uneven brightness of a display image displayed on a display unit is achievable according to various preferred embodiments of the present invention.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a general configuration of a television according to a first preferred embodiment of the present invention.

FIG. 2 is an exploded perspective view illustrating a configuration of a display module of the television according to the first preferred embodiment of the present invention.

FIG. 3 is a cross-sectional view illustrating the configuration of the display module of the television according to the first preferred embodiment of the present invention.

FIG. 4 is a cross-sectional view illustrating a display module according to a second preferred embodiment of the present invention.

FIG. 5 is an exploded perspective view illustrating a spacer member and a back cover according to a third preferred embodiment of the present invention.

FIG. 6 is a side view illustrating the spacer member according to the third preferred embodiment of the present invention.

FIG. 7 is a cross-sectional view illustrating the display module according to the third preferred embodiment of the present invention.

FIG. 8 is a cross-sectional view illustrating a display module according to a modified example of the first preferred embodiment of the present invention.

FIG. 9 is an enlarged view of an upper (Z1 side) portion as seen from the front side (Y1 side) and shows positional relationships among a rear frame, a light source unit, and an elastic member depicted in FIG. 3.

FIG. 10 is a diagram showing a display area of a liquid crystal cell and a light leakage area where light emitted from an LED disposed at an end leaks from an upper (Z1 side) end of an elastic member arranged as shown in FIG. 9.

### DETAILED DESCRIPTION OF THE PREFERRED EMBODIMENTS

Preferred embodiments according to the present invention are hereinafter described with reference to the drawings.

### First Preferred Embodiment

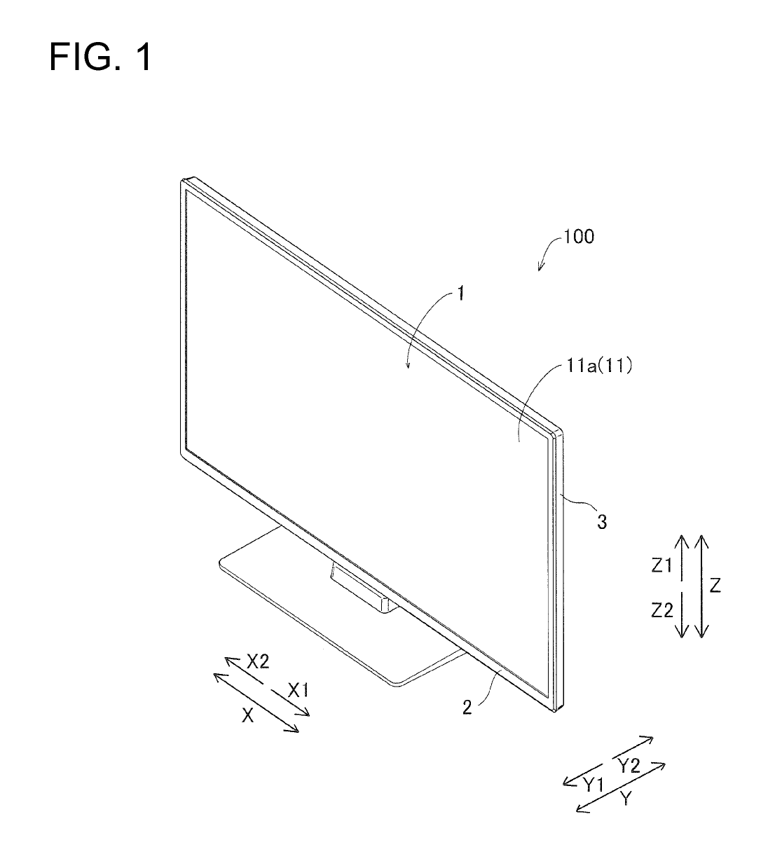

A configuration of a television 100 according to a first preferred embodiment of the present invention is now described with reference to FIGS. 1 through 3. In the following description, the image display side of the television 100 is defined as the front (Y1 direction). The side opposite to the front is defined as the rear (Y2 direction). The direction extending through the front and the rear is defined as the front-rear direction (Y direction). The directions crossing the front-rear direction at right angles are defined as the left-right direction (X direction) and the up-down direction (Z direction). The television 100 is an example of a “display device” according to preferred embodiments of the present invention.

As illustrated in FIG. 1, the television 100 according to the first preferred embodiment of the present invention includes a display module 1, a front cabinet (front housing) 2 covering the display module 1 from the front (Y1 direction), and a rear cabinet (rear housing) 3 covering the display module 1 front the rear (Y2 direction). The television 100 has a rectangular shape elongated in the left-right direction (X direction) as viewed from the front.

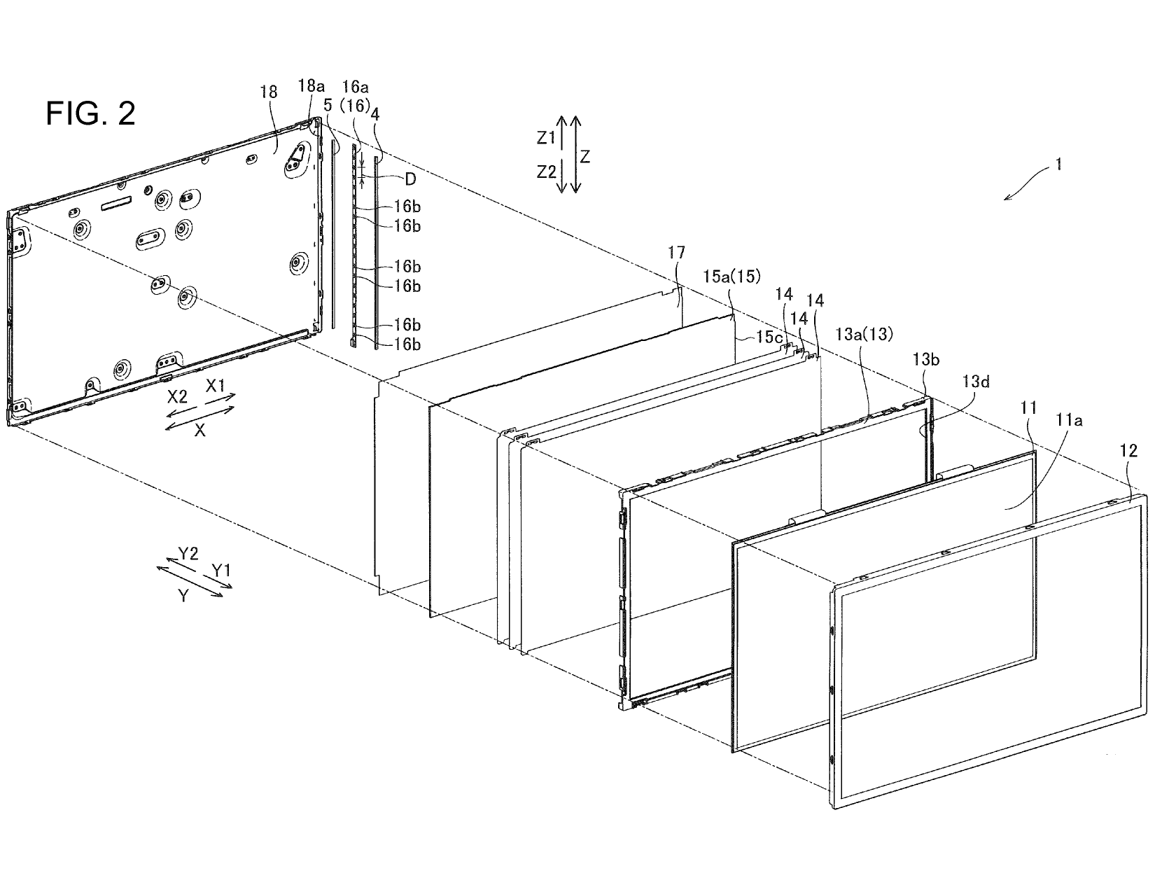

As illustrated in FIG. 2, the display module 1 includes a liquid crystal cell 11 including a display surface 11a on the front side (Y1 side), as a surface on which a display image is displayed. The display module 1 further includes a bezel 12 supporting the liquid crystal cell 11 from the front, and a mold frame 13 supporting the liquid crystal cell 11 from the rear. The display module 1 further includes various types of optical sheets 14, a light guide plate 15, a light source unit 16, a reflection sheet 17, and a back cover 18. The display module 1 further includes an elastic member 4, and a spacer member 5. The liquid crystal cell 11 and the mold frame 13 are examples of a “display unit” and a “display unit support member” according to preferred embodiments of the present invention, respectively. The spacer member 5 is an example of a “light guide plate support member” according to a preferred embodiment of the present invention.

The bezel 12 is a frame member attached to the mold frame 13 from the front (Y1 direction) of the mold frame 13 in such a condition that the liquid crystal cell 11 is sandwiched between the bezel 12 and the mold frame 13.

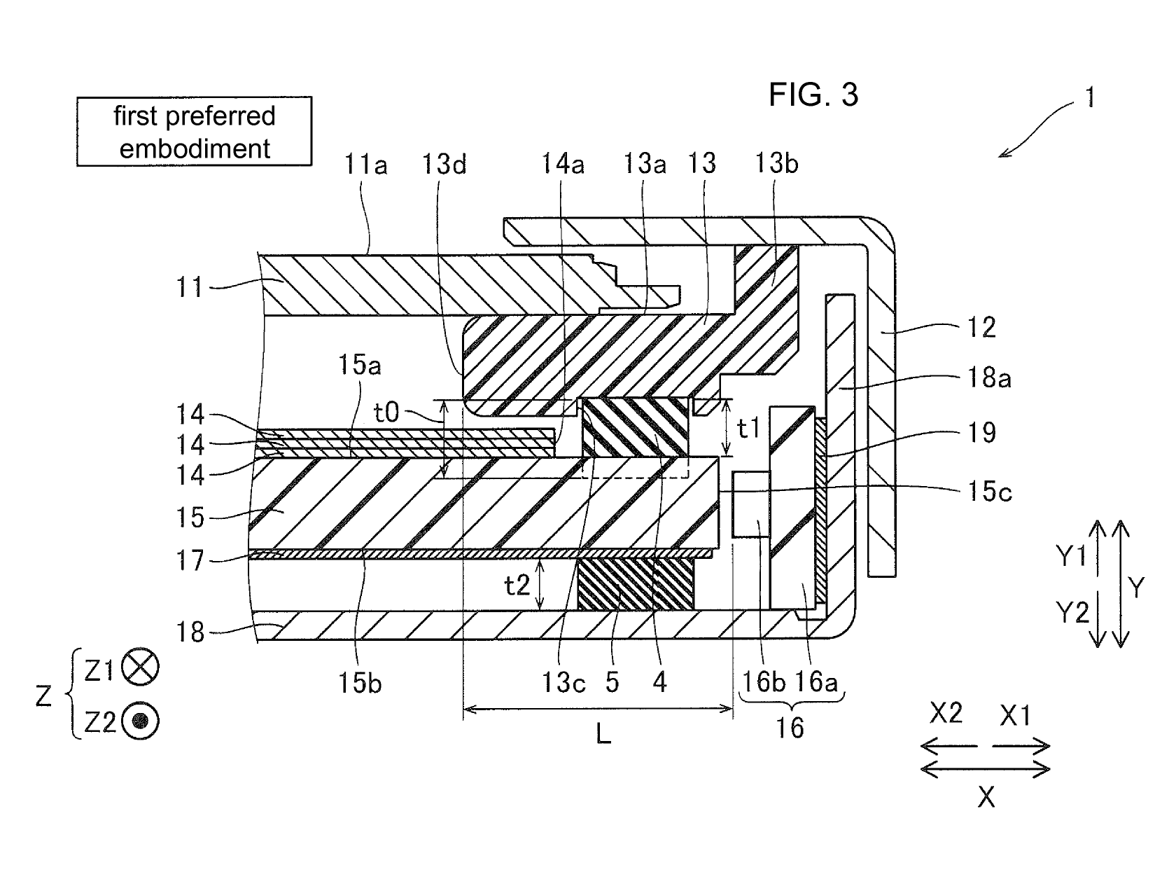

The mold frame 13 is a frame member made of resin. As illustrated in FIG. 3, an upper surface 13a and a wall 13b are provided on a front portion of the mold frame 13. The upper surface 13a is a surface on which an end of the liquid crystal cell 11 is disposed. The wall 13b is a wall projecting from the outside of the upper surface 13a toward the front (Y1 side). A front end of the wall 13b is configured to come into contact with the bezel 12. A recess 13c slightly recessed toward the front is provided in a rear portion of the mold frame 13. The recess 13c has a groove shape which extends in the up-down direction (Z direction). An opening 13d is formed in the frame-shaped mold frame 13 so that light having passed through the optical sheets 14 enters the liquid crystal cell 11 through the opening 13d.

As illustrated in FIG. 2, each of the optical sheets 14 is constituted by a diffuser panel or other types of function sheet, and has a rectangular shape elongated in the left-right direction (X direction). The plurality of optical sheets 14 are laminated in the front-rear direction (Y direction).

The light guide plate 15 is a plate-shaped component made of resin, and has a rectangular shape elongated in the left-right direction (X direction). The optical sheets 14 are laminated on a front surface 15a of the light guide plate 15 on the Y1 side, while the reflection sheet 17 is disposed on a rear surface 15b of the light guide plate 15 on the Y2 side.

As illustrated in FIG. 3, the light source unit 16 is disposed at a position facing to a light entrance surface 15c constituted by a side end surface of the light guide plate 15 on one side (X1 side) of the light guide plate 15 in the left-right direction (X direction). Accordingly, the television 100 (see FIG. 1) is a liquid crystal television of a so-called edge light type (side light type) including the light source unit 16 disposed on the side end surface side of the light guide plate 15. The light entrance surface 15c of the light guide plate 15 is configured to extend in the up-down direction (Z direction).

The light source unit 16 includes a substrate 16a extended in the up-down direction (Z direction) corresponding to an extension direction of the light entrance surface 15c, and a plurality of LEDs 16b (point light sources) mounted on the substrate 16a on the light entrance surface 15c side (X2 side). The plurality of LEDs 16b are disposed substantially at equal intervals (intervals D) in the up-down direction along the light entrance surface 15c. The LEDs 16b are an example of “light emitting elements” according to preferred embodiments of the present invention.

As illustrated in FIG. 3, the reflection sheet 17 is configured to reflect light emitted from the light source unit 16 such that the light travels toward the light guide plate 15 side (front side or Y1 side). According to this configuration, light emitted from the respective LEDs 16b as point light sources and entering the light entrance surface 15c of the light guide plate 15 is released as a surface light source from the front side of the optical sheets 14 by the functions of the optical sheets 14, the light guide plate 15, and the reflection sheet 17.

As illustrated in FIG. 2, the back cover 18 is constituted by a metal plate-shaped component, and has a shape elongated in the left-right direction (X direction). As illustrated in FIG. 3, the back cover 18 is disposed on the rear side of the light guide plate 15 (rear side or Y2 side). A wall 18a formed at the outer edge of the back cover 18 extends on the front side (Y1 side) of the back cover 18.

The light source unit 16 is attached to the wall 18a on the X1 side. More specifically, a surface of the substrate 16a on the side (X1 side) opposite to the side where the LEDs 16b are mounted is bonded to the X2 side surface of the wall 18a via a bonding member 19. This structure allows attachment of the light source unit 16 to the back cover 18. This configuration therefore dissipates heat generated from the light source unit 16 via the back cover 18.

As illustrated in FIG. 2, the elastic member 4 has a quadrangular prism shape, and extends in the up-down direction (Z direction) corresponding to the extension direction of the light entrance surface 15c of the light guide plate 15. As illustrated in FIG. 3, the elastic member 4 is disposed between the mold frame 13 on the light source unit 16 side (X1 side) and the light guide plate 15. The whole of the elastic member 4 is disposed on the outside (X1 side) of a side end surface 14a of the optical sheets 14 on the light source unit 16 side. A front side (Y1 side) surface of the elastic member 4 is fixed to the recess 13c of the mold frame 13 via a not-shown double sided tape. A rear side (Y2 side) entire surface of the elastic member 4 contacts the front surface 15a in the vicinity of the outer edge of the light guide plate 15.

The majority of light emitted from the LEDs 16b enters the light entrance surface 15c of the light guide plate 15. However, a portion of the light enters not the light guide plate 15 but a space between the front surface 15a of the light guide plate 15 and the mold frame 13. This light leaks toward the optical sheets 14 side (inside) via fine concavities and convexities which may be formed in the light guide plate 15, or a clearance which may be produced between the light guide plate 15 and the elastic member 4 as a result of a warp of the mold frame 13 or for other reasons. This leaking light enters the side end surface 14a of the optical sheets 14, or enters the liquid crystal cell 11. In this condition, areas confronting portions between the LEDs 16b become dark, while areas confronting the LEDs 16b become extremely bright (so-called a phenomenon of hot spots), on the light source unit 16 side of the liquid crystal cell 11. For reduction of these hot spots, decrease in the intervals D between the LEDs 16b (see FIG. 2) by raising the number of the LEDs 16b, or increase in a distance L between the mold frame 13 and the LEDs 16b is needed.

According to the first preferred embodiment, the elastic member 4 is configured to come into contact with the light guide plate 15 in a state of elastic deformation (compressive deformation), and exhibit non-translucency to prevent transmission of light, as illustrated in FIG. 3. More specifically, the elastic member 4 is preferably made of urethane foam. Urethane foam is an elastically deformable foam material (material having porous structure), and exhibits non-translucency capable of reducing transmission of light to some extent. At the time of attachment, the elastic member 4 in a state fixed to the mold frame 13 is pressed against the light guide plate 15. This condition brings the elastic member 4 into tight contact with the front surface 15a of the light guide plate 15, and also elastically deforms the elastic member 4 in the space between the mold frame 13 and the light guide plate 15 with compression in the thickness direction (Y direction). A thickness t1 of the elastically deformed elastic member 4 in the front-rear direction (Y direction) preferably ranges from approximately 70% to approximately 80% (inclusive) of a thickness t0 of the elastic member 4 prior to elastic deformation, for example. Compression (elastic deformation) of the elastic member 4 in the thickness direction decreases voids (pores) in urethane foam as a porous body, wherefore the elastic member 4 lowers translucency and raises non-translucency in comparison with the state prior to elastic deformation. Moreover, the elastic member 4 preferably fills fine concavities and convexities formed in the light guide plate 15 when brought into tight contact with the light guide plate 15.

According to the first preferred embodiment, therefore, the elastic member 4 reduces leakage of light toward the optical sheets 14 side (inside) after emission of the light from the LEDs 16b of the light source unit 16 toward the position between the mold frame 13 and the light guide plate 15. This structure prevents generation of hot spots even when the distance L between the LEDs 16b and the opening 13d of the mold frame 13 is reduced without changing the number of the LEDs 16b.

The spacer member 5 has a quadrangular prism shape similar to the shape of the elastic member 4. The spacer member 5 extends in the up-down direction (Z direction) corresponding to the extension direction of the light entrance surface 15c of the light guide plate 15. The spacer member 5 is disposed on the light source unit 16 side (X1 side) at a position between the light guide plate 15 (reflection sheet 17) and the back cover 18, and on the side (Y2 side) of the light guide plate 15 opposite to the elastic member 4 disposed on the front side (Y1 side) of the light guide plate 15. This structure allows the spacer member 5 to support the light guide plate 15 via the reflection sheet 17. The spacer member 5 is fixed to the back cover 18 via a not-shown double sided tape, for example. The spacer member 5 is disposed at a position overlapping with the elastic member 4 in the front-rear direction (Y direction).

The spacer member 5 is constituted by silicone rubber that is substantially non-deformable in an elastic manner. In other words, the spacer member 5 is less elastically deformable than the elastic member 4 made of urethane foam. This structure allows elastic deformation of the elastic member 4, rather than that of the spacer member 5, when the elastic member 4 is pressed against the light guide plate 15.

In addition, the spacer member 5 is configured to become a positioning reference for the light guide plate 15 in the front-rear direction (Y direction). More specifically, a thickness t2 of the spacer member 5 in the front-rear direction is adjusted such that the center of the light guide plate 15 in the front-rear direction (thickness direction) and the center of the LEDs 16b in the front-rear direction are aligned with substantially the same position when the light guide plate 15 is positioned on the front side (Y1 side) surface of the spacer member 5. According to this structure, the mold frame 13, the bezel 12, and the elastic member 4 do not affect the positioning of the light guide plate 15 in the front-rear direction, wherefore parameters affecting this positioning are allowed to be limited only to the positions of the LEDs 16b in the front-rear direction, the thickness t2 of the spacer member 5 in the front-rear direction, the thickness of the reflection sheet 17 in the front-rear direction, and the center position of the light guide plate 15 in the front-rear direction. The thickness of the reflection sheet 17 is sufficiently small and substantially ignorable. Accordingly, this structure allows reduction of the number of the parameters affecting the positioning, thus effectively reducing positional deviation between the light guide plate 15 and the LEDs 16b in the front-rear direction.

The elastic member 4 and the spacer member 5 are disposed at positions overlapped with the rear portion (Y2 direction) of the mold frame 13 in the front-rear direction (Y direction). According to this structure, the elastic member 4 and the spacer member 5 are located at positions not visible from the liquid crystal cell 11 side (front side). This arrangement reduces generation of unevenness in a display image displayed on the liquid crystal cell 11, as a problem caused by the presence of the elastic member 4 and the spacer member 5.

According to the first preferred embodiment, the following advantages are achieved.

According to the first preferred embodiment discussed above, the non-translucent elastic member 4 capable of preventing transmission of light is provided between the light guide plate 15 and the mold frame 13, and brought into contact with the light guide plate 15 in a state of elastic deformation of the elastic member. In this case, the elastic member 4 sandwiched between the light guide plate 15 and the mold frame 13 and contacting the light guide plate 15 in the state of elastic deformation is deformable in accordance with a change of the clearance between the light guide plate 15 and the mold frame 13 as a result of a warp or the like produced in the mold frame 13. This structure prevents generation of a clearance between the light guide plate 15 and the elastic member 4. Accordingly, this structure reduces light emitted from the light source unit 16, passing through a clearance between the light guide plate 15 and the elastic member 4, and entering the liquid crystal cell 11, and thus reduces a bright area around the light source unit 16 in the liquid crystal cell 11, and a dark area away from the light source unit 16 in the liquid crystal cell 11. As a result, uneven brightness (luminance unevenness) of a display image displayed on the liquid crystal cell 11 decreases.

According to the first preferred embodiment, the elastic member 4 is brought into contact with the front surface 15a of the light guide plate 15 on the outside (X1 side) of the side end surface 14a of the optical sheets 14 on the light source unit 16 side (X1 side). According to this structure, the elastic member 4 in contact with the light guide plate 15 outside the side end surface 14a of the optical sheets 14 reduces light emitted from the light source unit 16, passing through a clearance between the light guide plate 15 and the elastic member 4, and entering the side end surface 14a of the optical sheets 14. Accordingly, this structure reduces a bright area around the light source unit 16 in the liquid crystal cell 11 that is produced as a result of an effect of light having entered the side end surface 14a of the optical sheets 14, and a dark area spaced away from the light source unit 16 in the liquid crystal cell 11, and thus reduces uneven brightness of a display image displayed on the liquid crystal cell 11.

According to the first preferred embodiment, the plurality of LEDs 16b are disposed substantially at equal intervals (intervals D) in the up-down direction (Z direction) along the light entrance surface 15c (side end surface on the X1 side), while the elastic member 4 extends in the up-down direction corresponding to the extension direction of the light entrance surface 15c of the light guide plate 15. According to this structure, the elastic member 4 reduces uneven brightness of a display image displayed on the liquid crystal cell 11 in a wide range of the display image in the up-down direction corresponding to the extension direction of the side end surface of the light guide plate 15. In addition, the elastic member 4 prevents generation of a clearance between the light guide plate 15 and the elastic member 4, thus reducing light emitted from the LEDs 16b as point light sources, passing through a clearance between the light guide plate 15 and the elastic member 4, and entering the liquid crystal cell 11. This structure reduces dark areas confronting portions between the LEDs 16b on the light source unit 16 side of the liquid crystal cell 11, and extremely bright areas confronting the LEDs 16b on the light source unit 16 side of the liquid crystal cell 11 (so-called a phenomenon of hot spots), thus effectively reducing uneven brightness of a display image displayed on the liquid crystal cell 11. Accordingly, this structure eliminates the necessity of reducing the intervals between the LEDs 16b by raising the number of the LEDs 16b to prevent hot spots, thus avoiding a rise of the number of the LEDs 16b. In addition, this structure allows reduction of the distance L between the LEDs 16b and the opening 13d of the mold frame 13, while decreasing hot spots without the need for a rise of the number of the LEDs 16b. Accordingly, this structure allows reduction of the length of a frame-shaped portion of the frame-shaped mold frame 13 (length in the X direction in FIG. 3), and thus realizes narrowing of the frame (size reduction) of the television 100 by the corresponding distance.

According to the first preferred embodiment, the elastic member 4 is made of foam material (urethane foam) exhibiting non-translucency, and therefore is easy to elastically deform and also flexible when containing air. In this case, the elastic member 4 exhibiting non-translucency elastically deforms with ease to come into tight contact with the light guide plate 15. This structure effectively prevents generation of a clearance between the light guide plate 15 and the elastic member 4.

According to the first preferred embodiment, the spacer member 5 that is substantially non-deformable in an elastic manner (less elastically deformable than elastic member 4) is disposed on the side (rear side or Y2 side) of the light guide plate 15 opposite to the elastic member 4. This structure effectively prevents elastic deformation of the spacer member 5 rather than elastic deformation of the elastic member 4 when the elastic member 4 is pressed against the light guide plate 15 toward the spacer member 5 (rear side) for elastic deformation of the elastic member 4. Accordingly, this structure brings the elastic member 4 into contact with the light guide plate 15 with sufficient elastic deformation of the elastic member 4 and substantially without elastic deformation of the spacer member 5.

According to the first preferred embodiment, the mold frame 13 includes the recess 13c to which the elastic member 4 is fixed. According to this structure, the recess 13c facilitates positioning of the elastic member 4 on the mold frame 13, and prevents positional deviation of the elastic member 4 with respect to the mold frame 13.

### Second Preferred Embodiment

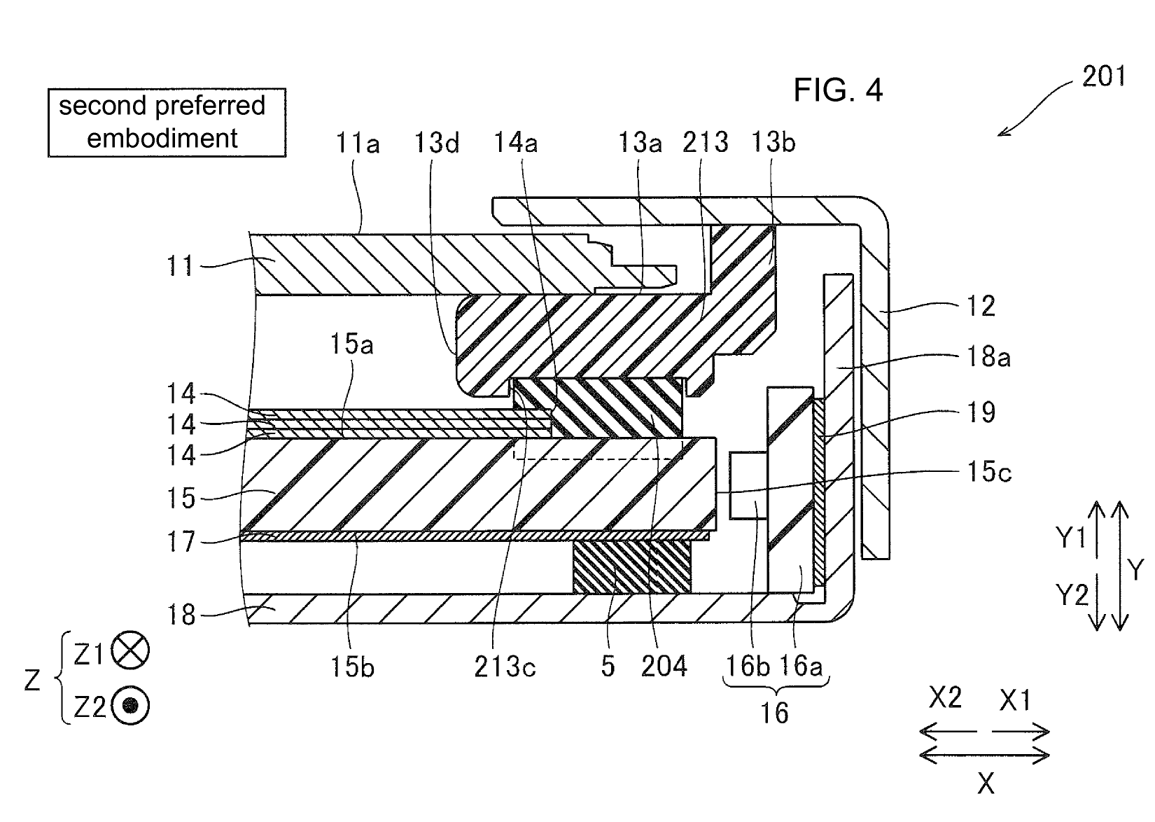

A second preferred embodiment of the present invention is hereinafter described with reference to FIG. 4. According to the second preferred embodiment discussed herein, an elastic member 204 presses the side end surface 14a of the optical sheets 14 and surroundings of the side end surface 14a, unlike the elastic member 4 whose entire area is disposed outside the side end surface 14a of the optical sheets 14 on the light source unit 16 side in the first preferred embodiment. Configurations similar to the corresponding configurations in the above-described preferred embodiment have been given similar reference numbers, and the same explanation is not repeated.

As illustrated in FIG. 4, a recess 213c of a mold frame 213 of a display module 201 according to the second preferred embodiment is larger in the left-right direction (X direction) than the recess 13c according to the first preferred embodiment (see FIG. 3). The mold frame 213 is an example of the “light guide plate support member” according to preferred embodiments of the present invention.

The elastic member 204 exhibiting non-translucency is larger than the elastic member 4 according to the first preferred embodiment (see FIG. 3) in the left-right direction (X direction), in correspondence with the length of the recess 213c. A portion of the elastic member 204 on the side (X2 side) opposite to the light source unit 16 comes into tight contact with the optical sheets 14 so as to press the side end surface 14a of the optical sheets 14 and the surroundings of the side end surface 14a. A portion of the elastic member 204 on the light source unit 16 side (X1 side) comes into tight contact with the front surface 15a of the light guide plate 15 so as to press the light guide plate 15.

Other configurations of the second preferred embodiment are similar to the corresponding configurations of the first preferred embodiment.

According to the second preferred embodiment, the following advantages are achieved.

According to the second preferred embodiment discussed above, the non-translucent elastic member 204 capable of preventing light transmission is provided between the light guide plate 15 and the mold frame 213, and brought into contact with the light guide plate 15 in a state of elastic deformation of the elastic member 204. As in the first preferred embodiment, this structure reduces a bright area in the vicinity of the light source unit 16 in the liquid crystal cell 11, and a dark area away from the light source unit 16 in the liquid crystal cell 11, thus decreasing uneven brightness (luminance unevenness) of a display image displayed on the liquid crystal cell 11.

In addition, according to the second preferred embodiment, the elastic member 204 is configured to press the side end surface 14a of the optical sheet 14 on the light source unit 16 side (X1 side) and the surroundings of the side end surface 14a. According to this structure, the elastic member 204 pressing the side end surface 14a of the optical sheets 14 and the surroundings of the side end surface 14a prevents positional deviation of the optical sheets 14, thus reducing damage to the light guide plate 15 caused by positional deviation of the optical sheets 14 as a result of vibrations or the like.

Other advantages produced by the second preferred embodiment are similar to the corresponding advantages of the first preferred embodiment.

### Third Preferred Embodiment

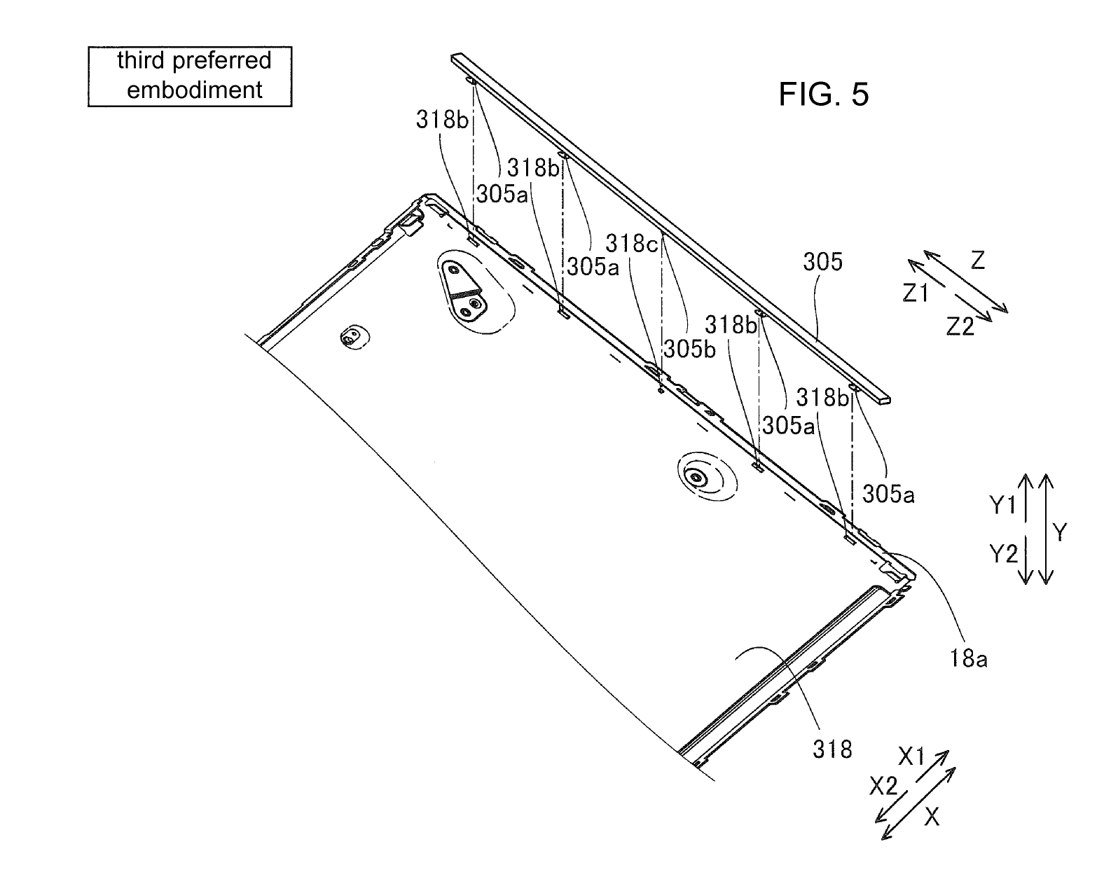

A third preferred embodiment of the present invention is hereinafter described with reference to FIGS. 5 through 7. According to the third preferred embodiment described herein, a spacer member 305 includes engaging portions 305a and 305b capable of engaging with a back cover 318, unlike the spacer member 5 fixed to the back cover 18 via the double sided tape in the first preferred embodiment. The spacer member 305 is an example of the “light guide plate support member” according to preferred embodiments of the present invention. Configurations similar to the corresponding configurations in the above-described preferred embodiments have been given similar reference numbers, and the same explanation is not repeated.

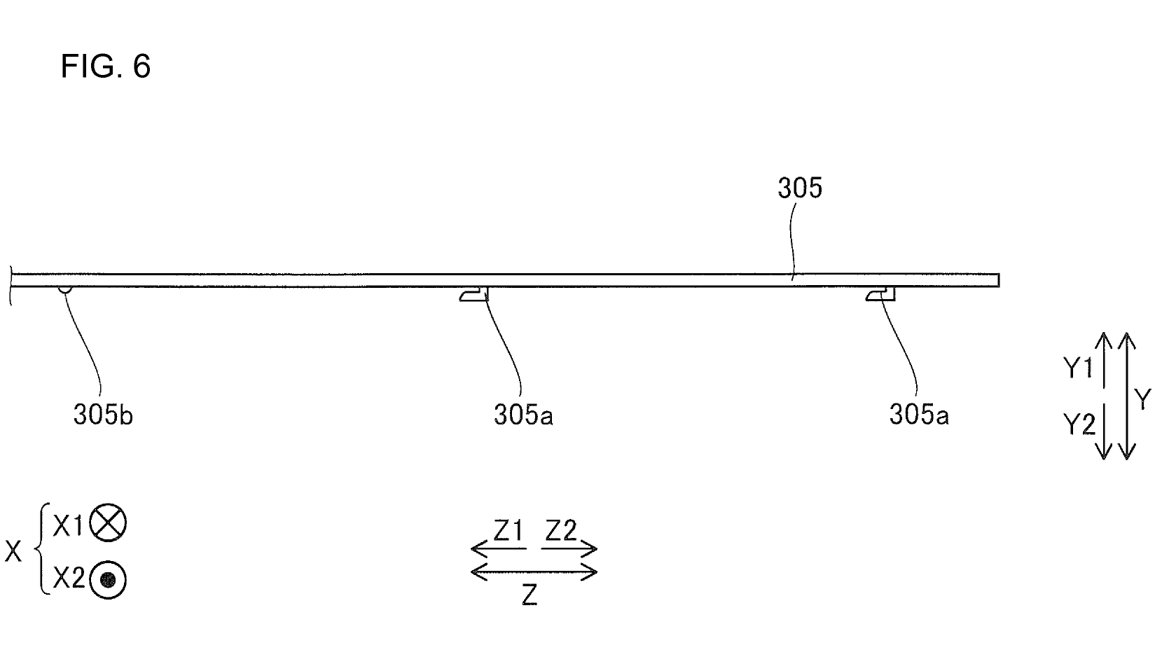

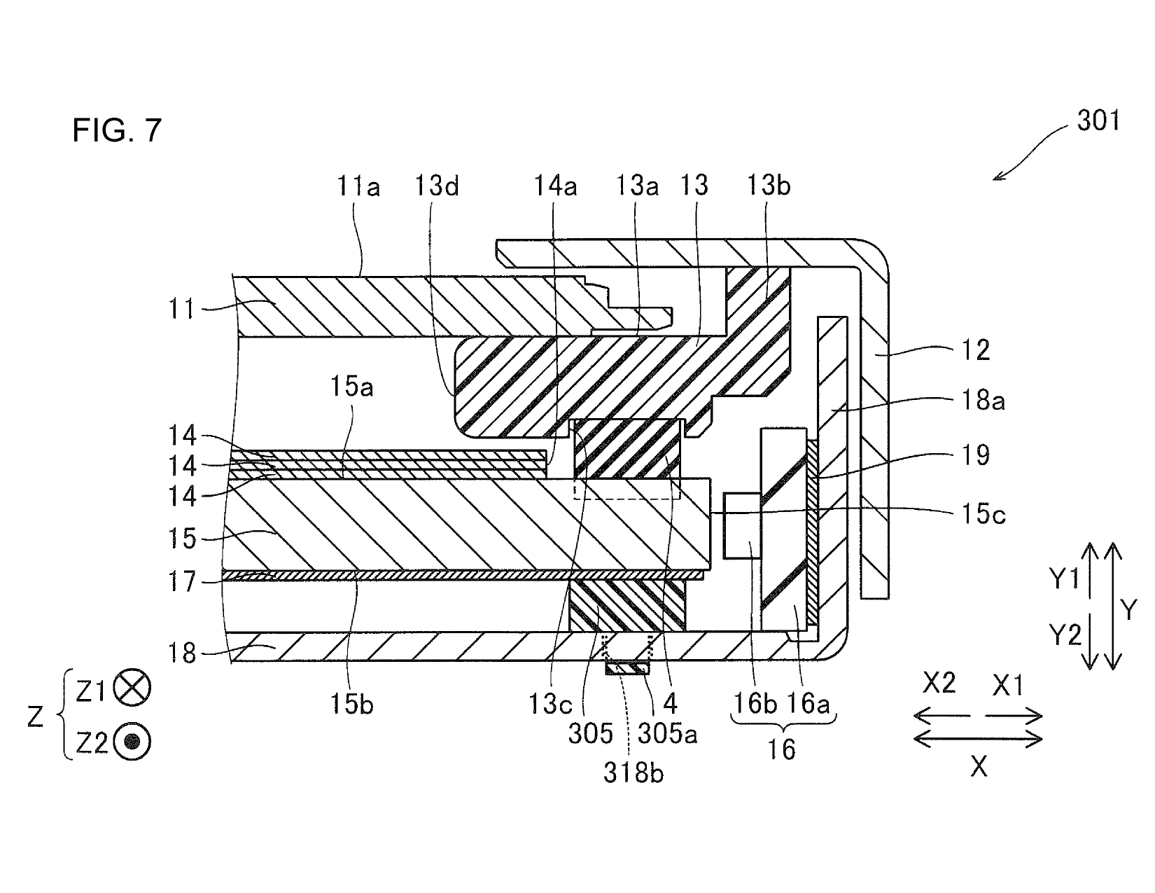

As illustrated in FIGS. 5 and 6, four hook-shaped engaging portions 305a, and a hemispherical engaging portion 305b are provided on the rear side (Y2 side) of the spacer member 305 of a display module 301 (see FIG. 7) according to the third preferred embodiment. Each of the four hook-shaped engaging portions 305a is configured to extend toward the rear from a rear surface (Y2 side surface) of the spacer member 305, and further extend upward (Z1 direction) from the rear side end of the engaging portion 305a. On the other hand, the hemispherical engaging portion 305b is provided substantially at the center of the spacer member 305 in the up-down direction (Z direction). The two of the four hook-shaped engaging portions 305a are disposed on the upper side (Z1 side) with respect to the engaging portion 305b, while the other two of the four engaging portions 305a are disposed on the lower side (Z2 side) with respect to the engaging portion 305b. The engaging portions 305a and 305b are located substantially at equal intervals in the up-down direction.

The spacer member 305 is constituted by resin material that is substantially non-deformable in an elastic manner. Accordingly, the spacer member 305 is less elastically deformable than the elastic member 4 (see FIG. 7) constituted by urethane foam. In addition, the hook-shaped engaging portions 305a and the hemispherical engaging portion 305b are easily molded integrally with the spacer member 305 constituted by resin material.

As illustrated in FIG. 5, the back cover 318 preferably includes four engaging holes 318b into which the four hook-shaped engaging portions 305a are fitted, and an engaging recess 318c into which the hemispherical engaging portion 305b is fitted. The engaging holes 318b are configured to penetrate the back cover 318. The engaging recess 318c is recessed in a hemispherical shape. With sliding the spacer member 305 upward (Z1 direction) in a state of insertion of the hook-shaped engaging portions 305a into the engaging holes 318b, the hook-shaped engaging portions 305a are caught by the back cover 318, while the hemispherical engaging portion 305b is fitted to the hemispherical engaging recess 318c. As a result, positioning and fixation between the spacer member 305 and the back cover 318 are completed as illustrated in FIG. 7.

Other configurations according to the third preferred embodiment are similar to the corresponding configurations of the first preferred embodiment.

According to the third preferred embodiment, the following advantages are achieved.

In the third preferred embodiment, as discussed above, the hook-shaped engaging portions 305a and the hemispherical engaging portion 305b capable of engaging with the back cover 318 are provided on the spacer member 305. This structure eliminates the need for fixation between the spacer member 305 and the back cover 318 via an additional double sided tape or the like, thus reducing the number of parts. In addition, sliding of the spacer member 305 upward (Z1 direction) completes positioning and fixation between the spacer member 305 and the back cover 318. This structure facilitates positioning and fixation of the spacer member 305, thus increasing assembly efficiency of the display module 301.

Other advantages provided by the third preferred embodiment are similar to the corresponding advantages of the first preferred embodiment.

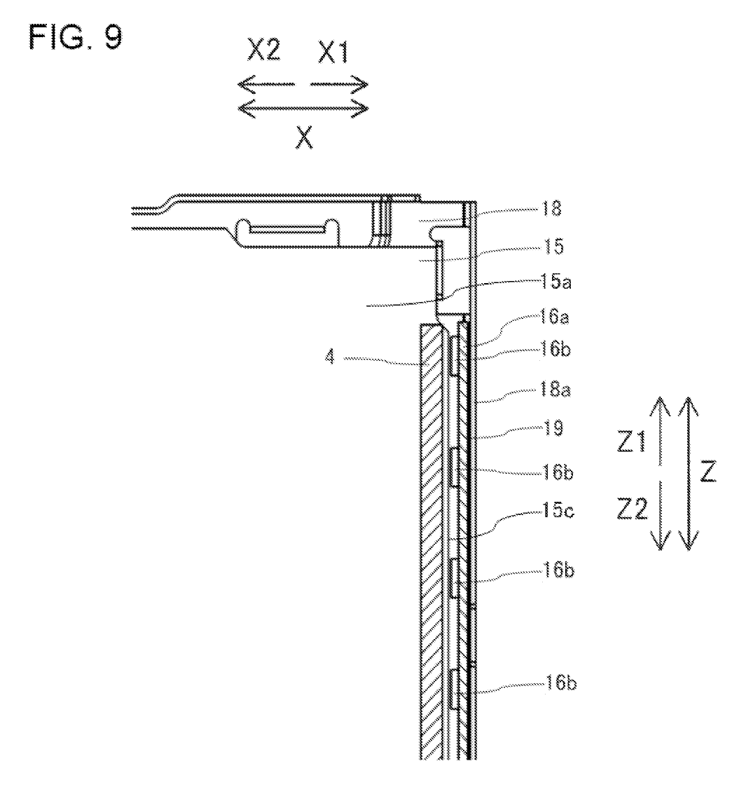

FIG. 9 shows positional relationships among the rear frame 18, the light source unit 16, and the elastic member 4 depicted in FIG. 3 in an enlarged view of an upper (Z1 side) portion as seen from the front side (Y1 side).

The plurality of LEDs 16b are mounted on an elongated rectangular substrate 16a at substantially equal intervals (intervals D) along the direction of length. The light source unit 16 that includes the plurality of LEDs 16b and the substrate 16a is disposed such that the arrangement direction of the LEDs 16b is parallel or substantially parallel to the light entrance surface 15c (side end surface on the X1 side) of the light guide member 15. Furthermore, the elastic member 4 is disposed on the front-side surface 15a of the light guide member 15 so as to be parallel or substantially parallel to the direction of arrangement of the plurality of LEDs 16b. As shown in the figures, the arrangement of the elastic member 4 and the light source unit 16 is set such that the position of the upper (Z1 side) end of the elastic member 4 in the up-down direction (Z direction) is located farther toward the upper side (Z1 side) than the position of the upper (Z1 side) end of the uppermost (Z1 side) LED 16b in the Z direction.

Moreover, although this is not shown, the arrangement of the elastic member 4 and the light source unit 16 is set such that the position of the lower (Z2 side) end of the elastic member 4 in the up-down direction (Z direction) is located farther toward the lower side (Z2 side) than the position of the lower (Z2 side) end of the lowermost (Z2 side) LED 16b in the Z direction.

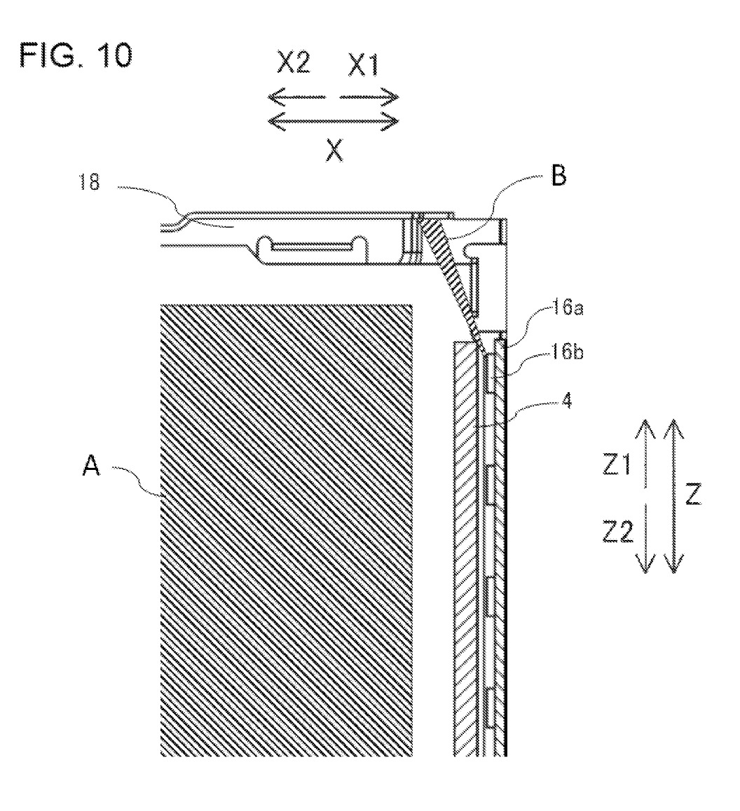

FIG. 10 is a diagram showing a display area A of the liquid crystal cell 11 and a light leakage area B where light emitted from the LED 16b disposed at an end leaks from the upper (Z1 side) end of the elastic member 4 in the arrangement relationship shown in FIG. 9. The display area A indicates a display area of an image that is displayed on the display surface 11a of the liquid crystal cell 11. Furthermore, the light leakage area B indicates an area where light emitted from the uppermost (Z1 side) LED 16b out of the plurality of LEDs 16b leaks in the left-right direction (X direction) without being blocked by the elastic member 4. The arrangement of the elastic member 4 and the light source unit 16 is set such that the display area A and the light leakage area B do not overlap.

Moreover, although this is not shown, the arrangement of the elastic member 4 and the light source unit 16 is set such that there is no overlapping of the display area A and an area where light emitted from the lowermost (Z2 side) LED 16b out of the plurality of LEDs 16b leaks in the left-right direction (X direction) without being blocked by the elastic member 4.

As was described above, by setting the arrangement of the elastic member 4 and the light source unit 16, light leaking from the LEDs 16b is not directed toward corner portions of the display area A. Accordingly, it is possible to prevent luminance unevenness caused by the luminance at a corner portion of the display area A from becoming higher than the luminance in other portions of the display area.

It should be understood that the respective preferred embodiments disclosed herein are only presented by way of example in any points, and are not intended to limit the present invention. The scope of the present invention is defined not by the description of the foregoing preferred embodiments, but only the scope of the appended claims. Accordingly, the scope of the present invention includes all modifications (modified examples) contained in senses and scopes equivalent to the appended claims.

For example, while the television has been discussed according to the first through third preferred embodiments as an example of the display device of the present invention, the present invention is not limited to this example. The present invention is applicable to other types of display devices as well as a television. For example, the present invention is applicable to ordinary types of display devices such as a display device for a PC (Personal Computer).

While the elastic members 4 and 204 are preferably constituted by urethane foam according to the first through third preferred embodiments discussed herein, the present invention is not limited to this example. The elastic member according to the present invention may be an arbitrary component which is elastically deformable. For example, the elastic member may be constituted by silicone rubber or expanded polyethylene (EPE) having low solidity. It is preferable that the elastic member is constituted by foam material.

While the spacer members 5 and 305 are preferably constituted by silicone rubber substantially non-deformable in an elastic manner according to the first through third preferred embodiments discussed herein, the present invention is not limited to this example. The spacer member according to the present invention may be an elastically deformable component. In this case, it is preferable that the spacer member is a component less elastically deformable than the elastic member.

While the spacer member 5 (305) preferably is additionally provided between the light guide plate 15 and the back cover 18 (318) according to the first through third preferred embodiments discussed herein, the present invention is not limited to this example. According to the present invention, a projection may be formed integrally with the back cover, which projection projects toward the light guide plate with a top portion of the projection in contact with the light guide plate. This structure eliminates the need for equipping the spacer member, wherefore reduction of the number of parts is achievable.

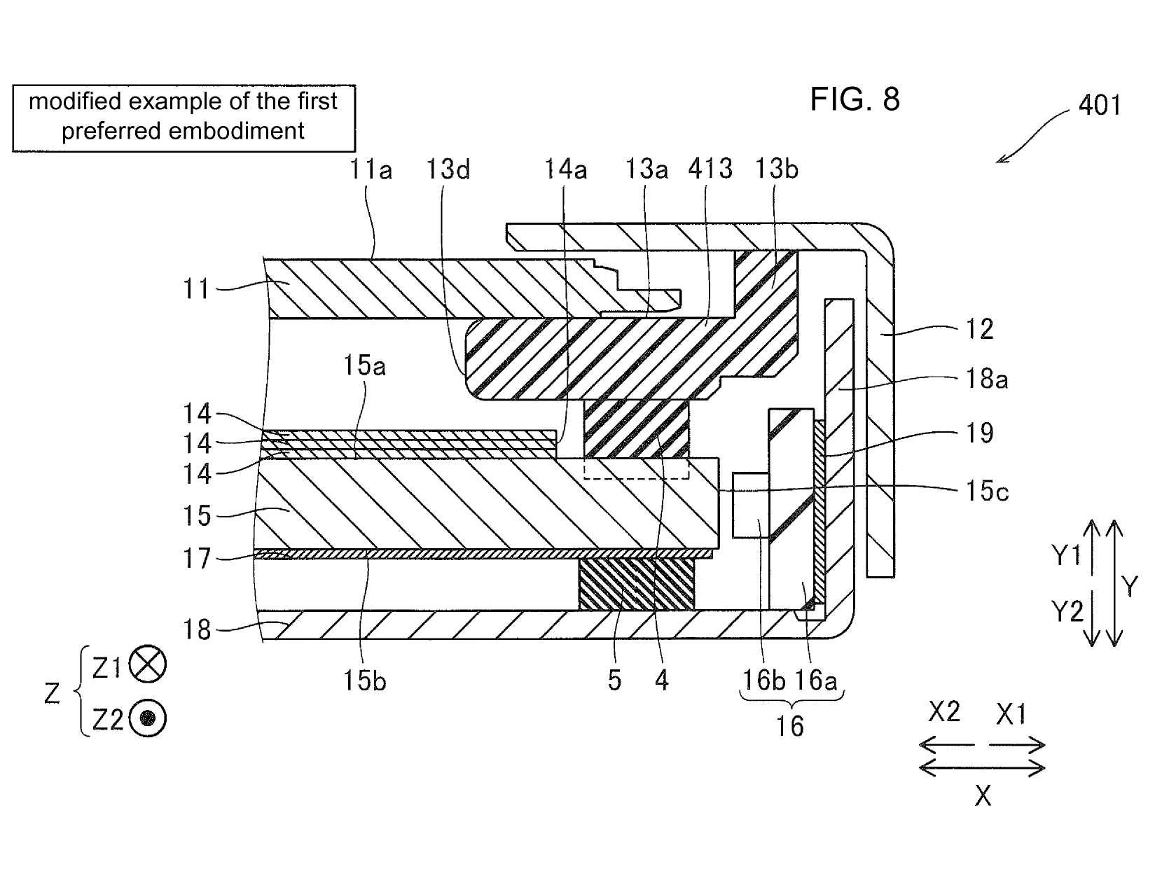

While the mold frame 13 as the recess 13c on which the elastic member 4 preferably is provided according to the first preferred embodiment discussed herein, the present invention is not limited to this example. According to the present invention, such a configuration is allowed which includes a display module 401 whose mold frame 413 contains no recess as in a modified example of the first preferred embodiment illustrated in FIG. 8. In this case, the elastic member 4 is attached to a flat rear surface of the mold frame 413 via a double sided tape. The mold frame 413 is an example of the “display unit support member” according to preferred embodiments of the present invention.

While the light source unit 16 preferably includes the plurality of LEDs 16b (point light sources) according to the first through third preferred embodiments, the present invention is not limited to this example. The light source unit according to the present invention may be a line light source such as a fluorescent lamp instead of LEDs.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A display device comprising:
a display unit;
a light source unit;
a light guide member that guides light emitted from the light source unit;
a display unit support member disposed between the light guide member and the display unit, and supporting the display unit; and
an elastic member disposed between the light guide member and the display unit support member, and brought into contact with the light guide member in an elastically deformed state of the elastic member.

2. The display device according to claim 1, further comprising:
an optical member disposed between the light guide member and the display unit; wherein
at least a portion of the elastic member is brought into contact with the optical member.

3. The display device according to claim 1, wherein
the light source unit includes a plurality of light emitting elements arranged along a side end surface of the light guide member; and
the elastic member extends in a direction parallel or substantially parallel with a direction in which the plurality of light emitting elements are arranged.

4. The display device according to claim 1, wherein the elastic member is made of material preventing transmission of light.

5. The display device according to claim 1, wherein the elastic member is made of foam material exhibiting non-translucency.

6. The display device according to claim 1, further comprising a light guide member support member disposed on a surface of the light guide member on a side opposite to a surface of the light guide member on which the elastic member is disposed.

7. The display device according to claim 6, wherein the light guide member support member is less elastically deformable than the elastic member.

8. The display device according to claim 7, wherein the light guide member support member is substantially non-deformable in an elastic manner.

9. The display device according to claim 1, wherein the display unit support member includes a recess in which the elastic member is disposed.

10. The display device according to claim 2, wherein the elastic member is disposed to press a side end surface of the optical member on the light source unit side, and an area around the side end surface.

11. The display device according to claim 6, wherein a length of the elastic member is larger than a length of the light guide member support member.

12. The display device according to claim 1, wherein a thickness of the elastic member in the elastically deformed state in a front-rear direction of the display device ranges from approximately 70% to approximately 80% of a thickness of the elastic member not in the elastically deformed state.

13. The display device according to claim 3, wherein a position of an end of the elastic member in a first direction along a direction of arrangement of the plurality of light emitting elements is closer to an end of the light guide member in the first direction than a position of an end of the plurality of light emitting elements in the first direction.

14. The display device according to claim 3, wherein the elastic member is disposed at a position where light from one of the plurality of light emitting elements reaches the display unit side through a side surface of the end of the elastic member in the arrangement direction is not directed toward a display area of the display unit.
